(19) United States
(12) Patent Application Publication
(10) Pub. No.: US 2018/0357389 A9
(43) Pub. Date: Dec. 13, 2018

(54) CLINICAL TRIAL MANAGEMENT AND SUPPLY SYSTEM AND METHOD

(71) Applicant: Innovative Supply Solutions, LLC, Southampton, PA (US)

(72) Inventor: Adam S. Warren, Richboro, PA (US)

(73) Assignee: Innovative Supply Solutions, LLC, Southampton, PA (US)

(21) Appl. No.: 15/434,165

(22) Filed: Feb. 16, 2017

Related U.S. Application Data
(60) Provisional application No. 62/297,156, filed on Feb. 19, 2016.

(51) Int. Cl. G06F 19/00; G06Q 10/08

(52) U.S. Cl. CPC G06F 19/363; G06Q 10/087

(57) ABSTRACT

A system and method for planning, forecasting, administering, and managing the logistics of the supply chain for clinical trials for the products of pharmaceutical and biotechnology concerns includes providing functionality that eliminates the need to understand and directly manage the complexities of conducting a clinical trial by way of an integrated system of functional modules that provide capabilities in the areas of supply chain planning and forecasting (including logistics, budgeting, labeling, accountability, and destruction), recruitment planning and forecasting, utilization monitoring and tracking, and patient assignment and randomization, as well as simulating the conduct of such a clinical drug trial.

### CROSS REFERENCE TO RELATED APPLICATION

This application claims the benefit of U.S. Provisional Application No. 62/297,156 filed Feb. 19, 2016.

### FIELD OF THE INVENTION

The instant invention relates to a system and method for planning, forecasting, administering, and managing the logistics of the supply chain for clinical trials for the products of pharmaceutical and biotechnology concerns.

### BACKGROUND OF THE INVENTION

Biotechnology and pharmaceutical companies conduct clinical trials to verify against such things as safety and efficacy before they bring their products to market. As studies expand, the associated complexities pressure product planning, trial setup, ongoing management, fulfillment logistics, and progress reporting. Many organizations lean toward product development given their domain expertise and, as such, lack the tools, organizational structure, or know how to effectively conduct these critical trials. These possible deficiencies generally manifest themselves in product timing, financial distress, or the inability to get the right product to the right place at the right time. While formulators toil away in the lab developing compounds and clinicians work innovating applications for the compounds, the organization's operations and supply chain often lag. This organizational imbalance creates opportunities for products and services focused on the supply chain that are tailored to the needs of this problem space.

The instant invention solves these problems in the aforementioned industry by providing functionality that eliminates the need to understand and directly manage the complexities of conducting a clinical trial. Instead, the system and method of this invention provides an integrated system of functional modules that provide capabilities in the areas of supply chain planning and forecasting, recruitment planning and forecasting, utilization monitoring and tracking, and patient assignment and randomization. Supply chain planning and forecasting includes logistics, budgeting, labeling, accountability, and destruction. Recruitment planning and forecasting includes randomization, screening, dropouts, and completion. Utilization monitoring and tracking includes patient forecasts, the full spectrum of expirations, supply logic, and trial and study-based aggregation and budgets.

In general, the system considers many complex variables that go into the process. These include expiration, patient recruitment, temperature across the supply chain, origin and destination geography, formulation restrictions, logistics, recalls, controlled substances, lot lineage, and adverse events.

The instant system leverages the robust variables it tracks and maintains in order to produce a wide range of useful capabilities. These include a management console, automated setup of clinical trials, cost optimizations, simulations across all disciplines, labeling for product, kitting and shipping, waste reduction, expiration, logistics, automated document creation, and clinical trial Interactive Response Technologies (IRT). The system can support a full spectrum of studies including multi-site, multi-country, double blind, adaptive, open label, crossover, titration, cohort, and flexible dosing. The system provides interactivity using a series of carefully crafted screens that provide a data input mechanism as well as outputs that provide a range of reports. These reports include planning, forecasting, actuals comparison, both product and clinical data analysis, and summarizations. All this is accomplished using an online system.

This system solves the problem inherent in the drug and biotechnology industries by reducing and possibly eliminating the need for users to have a working knowledge of supply chain and clinical trial demands while providing important capabilities in that area. These innovations revolve around simplification, artificial intelligence, intelligent integrations, just-in-time considerations, aggregation, web and mobile technologies, and accurate forecasting.

The prior art does not address these issues nor solve these problems, much less teach forecasting for logistics of clinical trials. For example, US patent application 2005/0149379 by Cyr et al provides teaching for supply related issues in a hospital setting based on patient supply data and care provider preference data, but does not deal with the logistics of a clinical trial which is orthogonal in scope to the clinical issues in a hospital. Further, US patent application 2008/0065418 by Byrom et al, while targeted to the clinical trial setting, teaches only in the context of drug accountability activities, particularly in the important area of destruction processes for oversupply of drugs, not a concern in the instant invention, nor does this reference solve or provide guidance with respect to the problems of a lack of efficiency, timeliness, and control in the administration of a clinical trial for a pharmaceutical concern that can be solved by accurate forecasting as taught in this specification.

### BRIEF DESCRIPTION OF THE DRAWINGS

FIG. 1 depicts the intersection of production and demand databases and the resultant forecast/simulation module according to the instant invention.

FIG. 2 sets forth in order the steps in the trial process as further described herein.

FIG. 3 shows the databases used in the instant system.

FIG. 4 is a flowchart for building a product according to the method described herein.

FIG. 5 is a flowchart for the manufacturing cycle of the current invention.

FIG. 6 depicts the relationship among products, trials, and scenarios in the system described herein.

FIG. 7 is a multifunctional flowchart for scenario set-up flow in the instant method.

FIG. 8 is a multifunctional flowchart for supply in the instant method.

### DETAILED DESCRIPTION OF THE INVENTION

For purposes hereof, “patients” are the subjects of a drug trial. These individuals receive “packs” or “kits” as part of the ongoing participation in the process. Patients are recruited into the trial and are serviced in a specific location. These locations are in turn serviced by depots. Patients are recruited into the trial through a variety of mechanisms including direct advertising and physician referrals. A potential participant is pre-qualified according to the study's particular parameters that might include demographic, medical, mental, and other measures. The rate at which patients can be recruited is dependent on many factors and can have significant impact on the process.

For purposes hereof, a “kit” or “packet” is a collection of items or goods that are provided to patients as part of a trial. These packets or kits might include a variety of items including but not limited to a specific dose of medication that is targeted for study. Kits need to be carefully constructed to follow the specific dosing regimen assigned to an individual patient as this is the key to successfully testing the safety and efficacy of a trial. Materials in the kit support the specific dosing so everything is properly aligned. For example, if a specific kit contains a specific dose, then the label and supporting documentation also aligns with whatever is pertinent to that dose. An important consideration is the lot lineage that goes into the specific medication dose contained in a specific kit.

For purposes hereof, a “depot” is an interim shipping point that provides materials (e.g., packs or kits) to the individual dispensing sites. The depot enables the stocking of materials before further distribution. Depots allow materials to be gathered in a central location to distribute to one or more countries and may be located in a different country than where the materials originated.

For purposes hereof, a “site” is a specific location where recruited patients go to interact with medical staff and are dispensed medication. Patients are assigned to these sites through the trial setup and ongoing procedures. It is here that patients receive packs or kits.

For purposes hereof, “expiration” or “expiry” connote the relative or absolute date at which a particular ingredient is set to be no longer useful or when it may need to be reevaluated. No ingredients or any other materials associated with this expiration are to be used after this date. Expiration is a key measure in the logistics chain as ingredients do not last indefinitely so the process should be optimized so that materials are not wasted.

Because temperature has significant impact on certain ingredients for drugs, for purposes hereof“storage temperature” is the predefined temperature conditions that is maintained based on available data for an ingredient. The temperature condition for investigation product is maintained through the supply chain. Often this temperature can be controlled at the origin and destination shipping points. However, the temperature of the ingredient while in transit, called the “shipping temperature” for purposes hereof, is also properly maintained if the ingredient is to maintain integrity.

For purposes hereof, the “formulation” is the manner by which different substances are combined in order to produce the final product. The formulations include relative amounts of active ingredients along with other substances. Generally, a particular formulation has a specific amount of the active ingredient. A formulation is also contained within some type of delivery such as a tablet, gelcap, powder, or a liquid that is designed for a specific type of delivery. In the ISS system, we consider these formulations a “recipe” for the final product, and these recipes are stored in our system.

For purposes hereof, the acronym “API” stands for active pharmaceutical ingredient and refers to the central ingredient designed to have a specific effect on a patient.

For purposes hereof, “controlled drug” or “controlled substance” are used as follows: there are specific substances or drugs that some governments feel the need to track or control more carefully given their impact on the population. While most pharmaceuticals have some level of tracking associated with them (e.g., can only be sold to licensed practitioners), tracking stops at a certain point in the logistics chain. Controlled drugs or controlled substances, in contrast, are intended to be tracked throughout the logistics chain.

For purposes hereof, a “lot” is a uniquely identified batch of an item often associated with a formulated product (e.g., tablet, capsule), API, ingredient, and packaged product. A “lot assignment” allows for items to be traced back to an original manufacturing date or location.

For purposes hereof, “randomization” or a “randomized control trial” is the activity or situation in which patients are randomly allocated different treatment variations or interventions under study. This might include different formulations as well as placebo. Randomization generally occurs after patients are considered qualified to participate but before the trial actually begins.

For purposes hereof, “serialization” is the adherence to an established sequence.

For purposes hereof, a “window” is a range or period of time within which an event might occur. An example of a window might be a date and +/−2 days.

For purposes hereof, a “threshold” is a supply strategy based on inventory levels that establish at what point in time an action for replenishment of stock would occur. This can be correlated to the quantity required to satisfy demand.

For purposes hereof, a “dropout” is the withdrawal/removal of a subject/patient from a trial.

For purposes hereof, a “scenario” is a specific instance of a trial simulation using defined parameters.

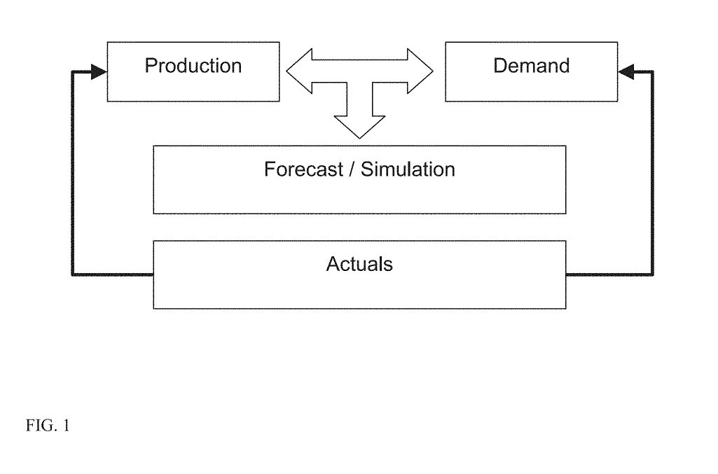

Referring to the drawings wherein like or similar references indicate like or similar elements throughout the several views, FIG. 1 depicts the peer relationship of production and demand in the instant system which allows for data to be driven into the forecast/simulation module. These demand calculations can be used to build an accurate simulation and/or be used to build an appropriate production setup. This “peer” relationship with production as well as accurate simulations are a key innovation allowing users to start with either known production considerations or demand setup while still creating an accurate clinical trial simulation which is an important and novel aspect of the present invention.

The following are descriptions of certain processes of the method covered hereby:

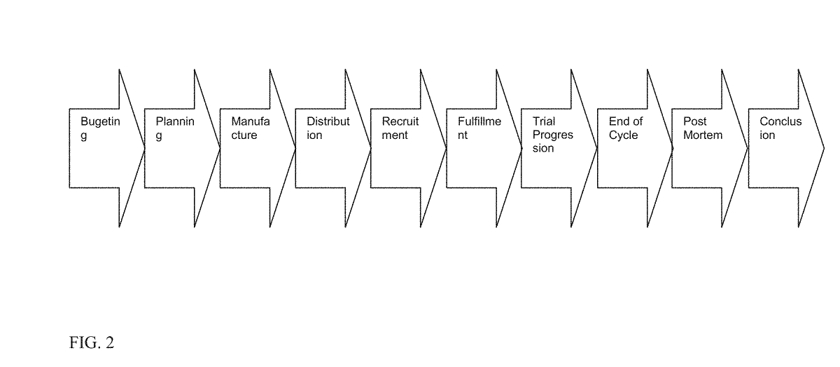

Trial Process: As shown in FIG. 2, a clinical drug trial process is a complicated undertaking with many different steps. There steps should be understood, planned for, and monitored in order to be properly managed. Steps in the process typically include budgeting, planning, manufacture, distribution, recruitment fulfillment trial progression, end-of-cycle, post mortem analysis, and conclusion. The invention covered hereby is a specialized system that has systematized this process reducing and possibly eliminating the need for users to have a complete grasp of all these steps and associated complexities.
Supply Chain: The current invention models and maintains the entire product supply chain. This lifecycle includes all the steps from beginning to end including raw ingredient acquisition, batch manufacture, packaging and labeling, distribution and logistics, demand and supply, and destruction. Given the ability to model and maintain, this module provides a full view in order to support complete accountability. Accountability is a key innovation in that user have a view of and can account for product locations throughout the supply chain and throughout product development and clinical trials. These supply plans are provided both as a planning tool in advance of trials, comparisons to forecasts during trials, and post mortem after trials have completed.
Logistics: The system covered hereby has the ability to consider, monitor, and track all aspects of shipping logistics. It takes into consideration lead times, costs related to shipping, regulatory requirements, and import & export requirements. Calculating accurate lead times involves the appropriate consideration of timing related to pre shipment requirements, acquiring appropriate permits/shipping documentation, courier times from origin to destination, destination customs, health authority, receiving/release times, and then shipping from destination termination to final destination. The aforementioned considerations do not need to be set up individually but rather are pulled from our pre-populated database of locations around the globe creating a near fully automated logistics setup. This not only limits time spent creating and calculating logistics but more importantly, significantly reduces errors when calculating actual project timing and requirements.
Budgeting: The budgeting module of the present invention considers the full spectrum of cost variables in order to provide accurate accounting both from a planning perspective and an actual perspective. One innovation is the ability to capture all costs including raw ingredient and APIs, manufacturing, packaging, labeling, storage, logistics, and destruction. These budgets are provided both as a planning tool in advance of trials, comparisons to forecasts during trials, and post mortem after trials have completed.

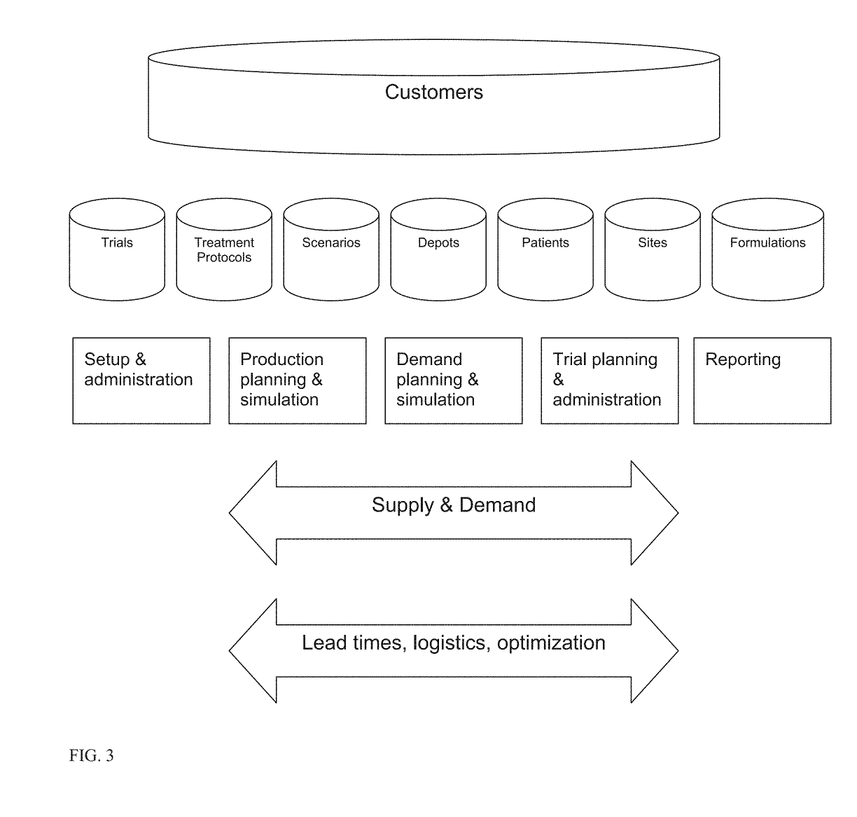

FIG. 3 shows databases for Customer, Trial, Treatment Protocols, Scenarios, Depots, Patients, Sites, and Formulation. The main modules of the system at issue are depicted as Setup & administration, Production planning & simulation, Demand planning & simulation, Trial Planning & administration, Reporting. Information and data follow bi-directionally throughout the system modules for Supply & Demand, and Lead times, logistics, optimization, as depicted by the bi-directional arrows.

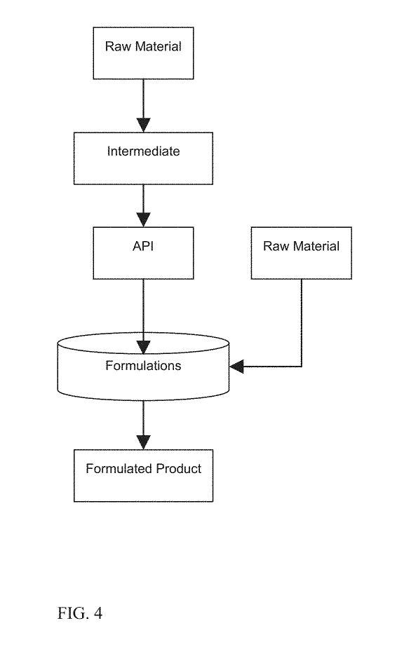

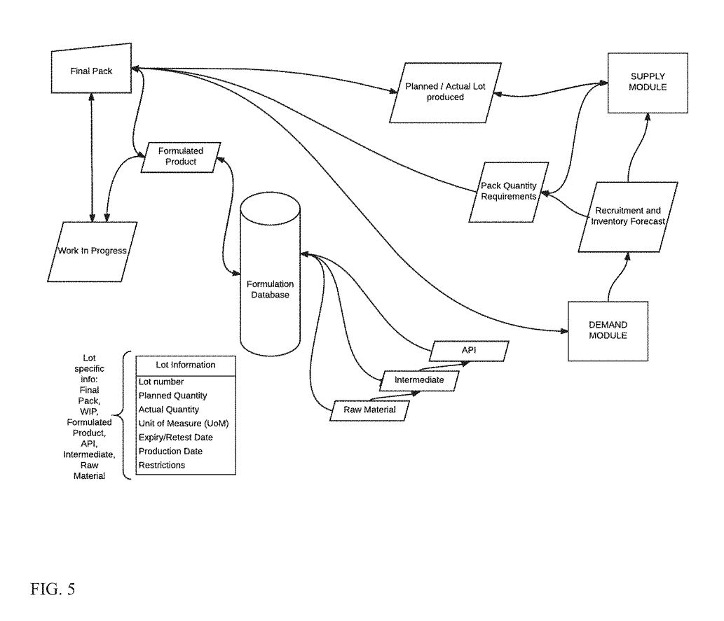

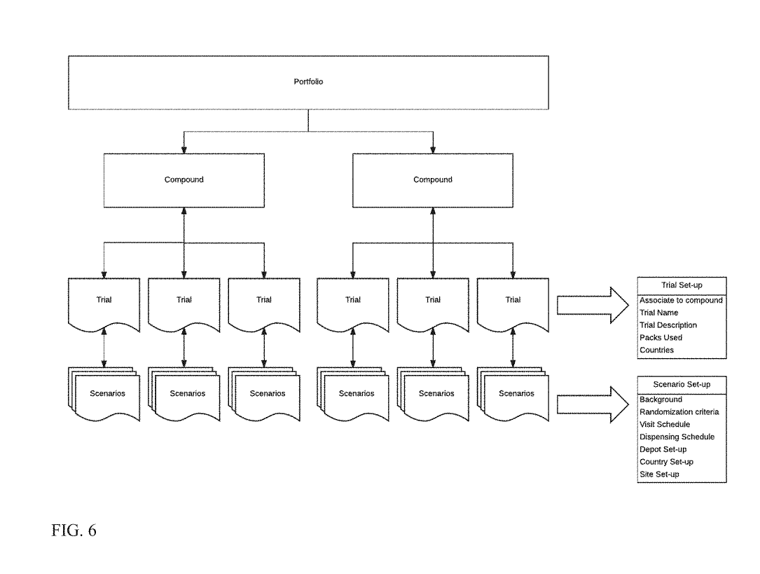

Production: The flowchart for building a product from raw material is shown in FIG. 4 and production as shown in FIG. 5 depicts the virtual model of the entire manufacturing/production cycle, and movement of the Final Packs into the Demand and Supply Module. The present system builds a virtual model of the entire manufacturing/production cycle in order to create accurate simulations of the process. This enables the system to accurately predict costs and timing as well as utilization planning. All relevant aspects of manufacturing go into the model including formulating product, unlabeled package (e.g., bright stock), labeled material, and ultimately shipping units. The module enables tracing of lot lineage from inception through destruction. These manufacturing plans are provided both as a planning tool in advance of trials, comparisons to forecasts during trials, and post mortem after trials have completed.
Demand: The method as covered hereby and as shown in FIG. 6 can determine demand for a given trial setup. These demand calculations can be used to build an accurate simulation and/or be used to build an appropriate production setup. This “peer” relationship with production as well as accurate simulations are a key innovation allowing users to start with either known production considerations or demand setup while still creating an accurate trial simulation.
Labeling: The labeling module of the instant system supports a complete library of labeling capabilities allowing products to be labeled properly at all stages. The module considers source and destination regulations, protocols dictated by the trial, governance through the process, product expiration, language translation, and lot lineage. The model also takes into consideration supply chain components enabling what is commonly referred to as “just in time” manufacturing and labeling. This is a key innovation that lowers costs and minimizes errors across the manufacture, distribution, and logistics process. The output of this module covers the entire spectrum of tradition labeling (e.g., all text) to include bar codes, QR codes, RFID, and near-field technologies.
Patient recruitment: Applicant's invention models patient recruitment by considering all the factors that have impact on the results. This enables the system to create a highly accurate future-looking forecast that supports budgeting, logistics, manufacturing, and regulatory plans.

The system considers elements including timing, assignments, visit schedules, drop-outs, location, demographics, and inclusion/exclusion criteria. These patient recruitment plans are provided both as a planning tool in advance of trials, comparisons to forecasts during trials, and post mortem after trials have completed.

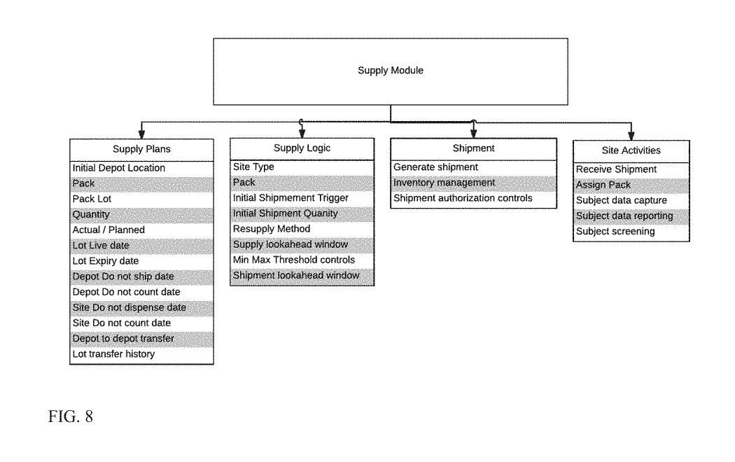

Supply: Supply logic in the disclosed system and method models product usage as a trigger for logistics. FIG. 8 addresses the issues of supply. Variables that drive this include shipping initial and seed quantities as well as ongoing resupplies. This module calculates the timing and quantity for each of these events while considering initial quantities, logistics, visit windows, utilization rates, and shipping frequency. The module also optimizes based on shipping costs. It supports a variety of methodologies including thresholds, predictive modeling, and a hybrid of the two. This is a key input to the supply chain, budgeting, and forecasting module.
Utilization considerations: One part of applicant's invention involves the creation of an accurate model of product utilization by considering the variables that impact usage. These include patient forecasts, the full spectrum of expirations, supply logic, trial and study-based aggregation, and budgets. These combine to accurately model utilization in order to predict product demand and patient forecasts. These forecasts are used as inputs to other modules of the system enabling areas such as shipping logistics, budgeting, and manufacture.
System Overview: The system covered by this patent application is a fully integrated drug development system enabling the oversight, planning, management, and reporting across multiple drug development disciplines. The system supports the process end-to-end from enterprise resource and planning (ERP), manufacturing, supply chain planning, automated and manual logistics, and actualization, all the way through subject recruitment planning (site and patient), patient randomization, accountability, and destruction. The system utilizes various databases, including customer-specific databases, to drive projections across the modules contained within this system. The system continually utilizes bidirectional planning, simulation-based forecasting, and data integration to detect variation from baselines and/or assumptions, enabling plan modification and optimization against time and cost. The data-driven system enables accurate and optimized planning, risk reduction, and cost and timing projections across the complete spectrum of drug development activities.

The production module of FIG. 5 offers a lean ERP capability. The lean ERP methodology provides targeted data points essential in managing a virtual supply chain. Since the system is built to service multiple sponsor/client companies, it begins with creating a compound and linking this to a specific “customer/sponsor”. Production starts with a final pack and can be expanded as far back in the production cycle as required. As an example, this can go back to specific ingredients in the formulation. The pack can also remain at the highest level—finished good—without having to build up from smaller components. A final pack will ultimately be used in the demand and supply modules. These are created and linked manually or via production recipes to include individual ingredients, such as API, Raw Material, Formulated Product, or a work in progress including specifics around planned quantity/yield, unit of measure, lead time, expiry, costs at each level of production activity, lot number, and lead time as well as complete traceability on where the pack has been deployed and/or planned on being deployed in studies/scenarios. Additional lot-specific characteristics are captured include lot number, planned and actual quantity yield, production and release date, expiry/retest/reevaluation date, and lot-specific restrictions (e.g., cannot be used in country “x”). Additionally, lots are tracked with complete traceability for where they are in use and planned on being used across studies and study scenarios as shown in FIG. 5.

The instant method allows label approval and generation processing contained within the production module, generating both randomized and open-label, variable-language labels, including just-in-time label generation for printing and applying at local facilities around the world.

The lean ERP functionality provides plans for production based on lead times and costs configured for each stage of production without the need for complex data inputs or theorems. The system performs forward and backward planning-based data elements including batch size, expiry, enhanced expiry controls (such as do not ship, do not dispense, and do not count dates), and anticipated demand. Anticipated demand is based on trials simulated via the Demand Module. Actual supply utilization is based on data derived via the Supply Module. The system automates logistics using lead times and country-specific regulatory requirements for deploying product to various depots and site locations throughout the world.

The demand module of the present invention builds a view across multiple products, trials, and scenarios. It allows for iterative development and intuitive setup. The trial setup includes allocating packs from the Production Module and assigning countries that may participate in the study as shown in FIG. 6.

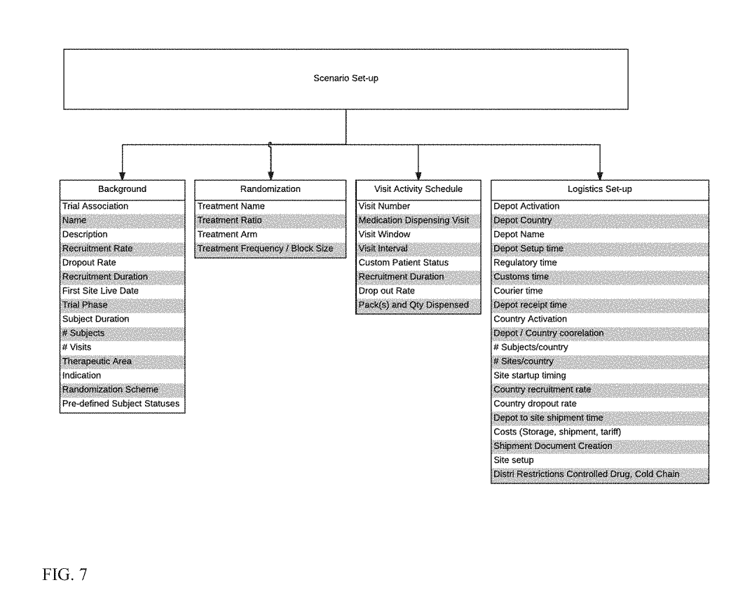

Scenario setup as shown in FIG. 7 utilizes system-designed defaults to ensure build speed and reduce errors across all phases of demand. This includes recruitment rates, dropout rates, country-specific parameters, and site values.

The randomization module of this system is designed to assign subjects to a treatment. The methodology is based on site blocks, country, region, and central/trial randomization schemes. The system utilizes a double-randomization approach which allows the system to route subjects, based on pre-study assumptions, to iterations within a treatment regime while maintaining the planned percentages or ratios between overall treatment groups. Once the study is live, actual data can then be utilized to make adjustments to the pre-study assumption, and this be used to re-run an updated scenario.

Subject visits include setting up a visit schedule (anticipated duration+a flexible visit window+/−interval) to capture all planned subject visits, inclusive of both visits where drug dispensing does as well as does not occur (clinical visit only). Drop-out percentages are captured at each anticipated visit to simulate when a percentage of the study populace is expected to stop participating in the study. Additionally, the customized subject statuses from the setup are linked to specific visits and a drug dispensing plan (e.g., what pack(s) and how much) to be dispensed at each visit is captured. This enables a product need over time for subjects to be calculated.

The timing and site/location that patients can be expected is directly correlated to the logistics established within the covered system and method which encompasses the setup and activation of depots/countries to consider logistics, timing, and cost optimizations. These calculations go to a granular level including down to specific packs. Site and pack availability is automatically calculated by the system depending on variables such as logistics, cost optimization, and patient recruitment. Subsequently, product demand is calculated based on the aforementioned demand to include subject availability and visit and dispensing schedules. Targeted data is used to generate forecast/plan variance and for supporting statistical Monte Carlo simulations.

Lead times for regulatory activities, import/export, shipment preparation, courier transit time, customs clearance and receipt at destination, cost for shipment, courier handling, storage, and tariffs are all factored into the calculations for supply timing, availability, and cost projections. The system produces important regulatory and shipping documents not limited to pro forma invoices, commercial invoices, and customized country-required documentation. All shipment documentation is stored in a repository within the system for later retrieval and analysis.

Demand reports are generated that confirm sites, subjects, and timing based on the scenario setup and assumptions. The demand scenarios are available for transfer into the Supply Module of this system.

Once a scenario demand profile is complete, the system's supply module is invoked to plan and manage specific pack lots. The supply module allows data to be aggregated across multiple scenarios, trials, and compounds to enable oversight, management, and reporting at all visibility levels including trial, compound, and portfolio. Supply takes into account additional data for quantities of a specific lot, depot location, and enhanced expiry controls which include lead times for stopping distribution and dispensing activities at the depot and sites, respectively. Prior to the scenario being live, Depot supply is planned and anticipates and automates supply logistics. Depot-to-depot transfers are planned—if necessary—in a similar fashion. All depot inventory and depot transfers are tracked and reported during the planning and actualization over the course of the study. The system supports a specific type of dating called “do not count” that enables additional shipments to be triggered either manually or automated as a factor of the expiry date and depot-to-depot factors as well as depot-to-site lead times which include regulatory, customs, courier transit, and receipt. Logistics/shipment activities are also triggered by supply logics that are pre-programmed into the method and system of this invention.

Initial shipments to sites—called site seeding—is controlled by site type, location, and shipping unit quantity. The trigger for these initial shipments is customizable and optimized for pack/shipping unit quantity and based on specific events, such as site opening, first subject enrolled, and first subject dosed, as well as a customized trigger that enables the initial shipment to be set to any specified site event.

Resupply shipments have various supply logics that can be customized to simulate threshold, predictive, and hybrid resupply methodologies. Threshold controls work based off of a defined minimum level that, once breached, triggers a resupply shipment supply up to a maximum level of packs. Predictive logic considers anticipated demand based on planned subject visits and pack utilization over a customized time period. This is called a supply look-ahead window. The supply look-ahead window captures demand for packs at a specific site and initiates shipments based on a customized shipment window. The shipment window aggregates the total number of packs needed for a given site until the next shipment window is achieved. Hybrid controls take into account a combination of both threshold and predictive logic and triggers shipments based on a breach of the low threshold and/or the look-ahead window. The Hybrid logic will also add additional buffer packs to the shipment based on the difference between the anticipated packs remaining plus the site min/max level at the end of the shipment window.

Applicant's system enables generation and electronic transfer to shipping inventory. The output can be produced as human readable information, printed or transmitted electronically to a depot. Inventory quantities and status—such as release or quarantine—regulatory shipment authorizations and controls must be met in order to generate the shipment request and are managed via various stage gate controls within the ISS platform. Inventory status and quantities are updated on a transactional basis for live shipment activities and monitored against forecasts/simulation activities.

The inventory can be received and assigned to subjects via web interface. Subjects can be enrolled upon meeting inclusion criteria and demographics created and managed via the system itself, or by paper processes. This depends on the scope of the trial as determined by the trial sponsor. Clinical data, such as demographics, safety, and efficacy data, can be captured within the software of the system or integrated with other clinical electronic data capture devices or systems. Accountability, returns, and destruction tracking are available to close out the supply chain back to the source lots (Packaging, Formulated Product, API, and raw material). This full-cycle accountability is an important component to oversight of trials. The ISS Platform is unique in performing the end-to-end process from ERP, manufacturing, and supply chain planning as well as utilization all within one seamless platform.

Although specific arrangements and methods have been described herein, other suitable arrangements and methods may be used as indicated with similar results.

Other modifications of the present invention will occur to those skilled in the art on reading the instant disclosure. Those modifications are intended to be covered within the scope of this invention.

What is claimed is:

1. A system for conducting a clinical trial comprising:
at least one database;
a processing unit controlling access to and manipulation of said database;
a computer program containing instructions relating to the conduct of a clinical trial in control of said processing unit;
a terminal for human access to and control of such computer program in accordance with the following steps of conducting a clinical trial for a certain drug: budgeting, planning, manufacturing, distributing, recruiting patients, trial progression, end-of-cycle, post mortem analysis, and conclusion of trial; whereby the desired results of said clinical trial for said drug are obtained in an efficient and timely manner.

2. A system for simulating a clinical trial comprising:
at least one database;
a processing unit controlling access to and manipulation of said database;
a computer program containing instructions relating to the simulation of a clinical trial for a certain drug in control of said processing unit; and
a terminal for human access to and control of such computer program, whereby the desired results of said clinical trial are simulated for analysis.

3. A method for conducting a clinical trial comprising the steps of:
budgeting for a clinical trial for a certain drug;
planning for said clinical trial;
manufacturing the drug to be tested in said clinical trial;
recruiting patients for said clinical trial;
distributing drugs to said patients;
managing the progression of said clinical trial;
managing the end-of-cycle of said clinical trial;
analyzing the results of said clinical trial; and
concluding said clinical trial, whereby the desired results of said clinical trial for said drug are obtained in an efficient and timely manner.

4. A method for simulating a clinical trial comprising the steps of:
budgeting for a clinical trial for a certain drug;
planning for said clinical trial;
simulating a universe of patients for said clinical trial;
simulating the distribution of drugs to said patients;
simulating the progression of said clinical trial;
simulating end-of-cycle results of said clinical trial; and
analyzing the results of said simulated clinical trial.

5. A tangible computer readable recordable medium in which is resident a computer program for control of the conduct of a clinical trial for a certain drug according to the steps of budgeting, planning, manufacturing, distributing, recruiting patients, trial progression, end-of-cycle, post mortem analysis, and conclusion, whereby the desired results of said clinical trial for said drug are obtained by the use of said program in an efficient and timely manner.

6. A tangible computer readable recordable medium in which is resident a computer program for simulation of a clinical trial for a certain drug according to the steps of budgeting for a clinical trial for a certain drug; planning for said clinical trial; simulating the makeup of a universe of patients necessary for said clinical trial; simulating the distribution of drugs to said patients in said clinical trial; simulating the progression of said clinical trial; simulating end-of-cycle results of said clinical trial; and analyzing the results of said simulated clinical trial by the use of said program.
